(19) United States
(12) Patent Application Publication
(10) Pub. No.: US 2013/0270261 A1
(43) Pub. Date: Oct. 17, 2013

(54) Microwave plasma torch generating laminar flow for materials processing

(71) Applicants: Kamal Hadidi, Somerville, MA (US); Makhlouf Redjdal, Storrs-Mansfield, CT (US)

(72) Inventors: Kamal Hadidi, Somerville, MA (US); Makhlouf Redjdal, Storrs-Mansfield, CT (US)

(21) Appl. No.: 13/445,947

(22) Filed: Apr. 13, 2012

(51) Int. Cl. H05B 6/64

(52) U.S. Cl. 219/686

(57) ABSTRACT

A microwave plasma torch providing two laminar flows is described. Two laminar flows are created using a set of at least three concentric, staggered dielectric tubes connected to a pressurized gas source. An inner laminar flow entrains injected particles entering the plasma. An outer laminar flow creates a sheath around the plasma and prevents it from attaching to the walls of the plasma torch. The entry point of the gas source is designed to ensure laminar flow for both the entrainment of the particles and for the shielding of the plasma plume. The uniform processing conditions results in uniform particles and a homogenous materials distribution. This enables a final product with improved thermal properties, improved corrosion and wear resistance and a higher tolerance to interface stresses. The microwave plasma torch can be used for producing nanomaterial powder and for spray coating materials onto various substrates.

### TECHNICAL FIELD

The present invention is generally directed to a microwave plasma torch used in materials processing. More particularly, the present invention is directed to a microwave plasma torch which generates laminar flow during materials processing. The laminar flow produced allows for the production of uniform particles and a homogenous materials distribution, which leads to improved characteristics in the final product. Even more particularly, the present invention is directed to a microwave plasma torch which can be used for nanomaterial powder production and for spray coating materials onto various substrates.

### BACKGROUND OF THE INVENTION

When processing materials using a microwave plasma torch, a gas swirl flowing at high velocity prevents the plasma from attaching to the walls of the dielectric tube. This swirl gas subjects the materials to turbulent flow causing the materials to travel from the center of the tube, in line with the materials injection point, towards the surface of the tube wall, where the temperature is significantly lower than in the center of the tube. This subjects the materials to significantly asymmetrical temperature profiles and results in non-uniform particles and non-homogenous materials, which adversely affects the properties of the final product. Thus there is a need for a uniform processing environment for materials processed using microwave plasma. However, no such method has yet been reported.

From the above, it is therefore seen that there exists a need in the art to overcome the deficiencies and limitations described herein and above.

### SUMMARY OF THE INVENTION

The shortcomings of the prior art are overcome and additional advantages are provided through the use of a plasma torch apparatus that is capable of producing laminar flow patterns.

In accordance with one embodiment of the present invention there is provided a method for producing laminar flow inside a plasma forming chamber while maximizing the entrainment velocity of injected particles used in materials processing. The present invention accomplishes this through the use of a plasma torch possessing several features.

The plasma torch of the present invention comprises a set of at least three staggered tubes fused together at one end. The lengths of the tubes are selected to provide laminar flow patterns for both particle entrainment and for protection from the plasma plume. The inner tube is the shortest and the outer tube is the longest. The length differential between the inner tube and the middle tube is chosen to provide a flow path for the gases so as to prevent turbulent flow effects from forming. A second laminar flow is also formed between the outer and middle tubes, which serves to protect the walls of the outer tube from contact with the plasma plume.

Another feature which promotes laminar flow is provided by gas injection ports which are angled relative to the central axis of the torch. This serves to ensure the uniformity in the laminar flow of gases inside the plasma torch.

Thirdly, the inner tube is tapered at the open end. This serves to reduce turbulent effects when the entrainment gas meets the injected particles at the open end of the inner tube.

A further feature of the current invention is that the spacing between the inner and middle tubes is selected so as to increase the entrainment velocity of the injected particles.

A source of microwave energy propagated by a waveguide is used to create a plasma plume at the open end of the middle tube. The maximum outside diameter of the outer tube is generally selected to be inversely proportional to the frequency of the microwave radiation.

Therefore, an object of the present invention is to provide a laminar flow environment, free of turbulent flow effects, for the material that goes through the plasma resulting in nanoparticles with uniform sizes and shapes and a homogenous materials distribution.

It is another object of the present invention to enhance plasma processing of materials so as to provide a product with improved thermal properties, improved corrosion and wear resistance and a higher tolerance to interface stresses.

It is still another object of the present invention to keep the tube walls cleaner.

It is also another object of the present invention to keep the tube walls cooler.

The microwave plasma torch described in this application can be used to produce nanomaterial powder and for the spray coating of materials onto various substrates.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 illustrates a preferred embodiment of the plasma torch which uses staggered dielectric tubes to form the plasma torch used in materials processing, in accordance with the present invention;

FIG. 2 illustrates details of the gas communication process which ensures uniform entrainment of process particles and the minimization of turbulence inside the plasma torch;

FIG. 3 illustrates a preferred embodiment of gas flow inputs into the plasma torch to ensure uniform laminar flow of gases inside the plasma torch; and

FIG. 4 illustrates a preferred embodiment of the plasma torch inside the plasma chamber which is part of a microwave plasma apparatus which produces plasma for materials processing.

FIG. 5 illustrates details of using the plasma torch to process a combination of fluids using more than one particle feed source.

### DETAILED DESCRIPTION

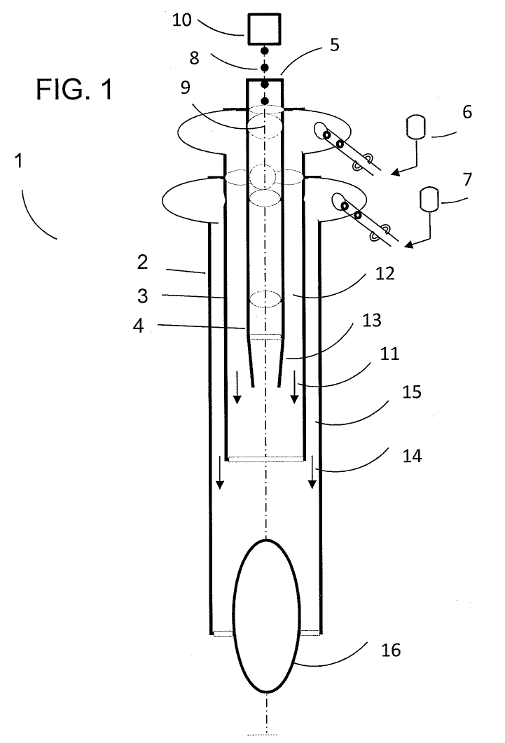

Referring to FIG. 1, a microwave plasma torch apparatus 1 for materials processing, in accordance with a preferred embodiment of the present invention, includes three concentric dielectric tubes 2, 3, and 4. The tubes are fused together at one end and provide input 5 for particle injection, as well as inputs 6 and 7 for process gas flows. Input 5 into tube 4 is used to inject process particles 8 (exemplary particles shown), along an alignment axis 9, using injection apparatus 10, which can be a solid particle feeder, such as a powder feeder, or a high frequency droplet maker. These devices are well known in the plasma processing arts. Input 6 is a pressurized source that provides a core laminar flow 11 through narrow gap 12, which accelerates process particles 8 at open end of tube 4, with laminar entrainment taking place in tube 3. The width of gap 12 is chosen to shield the injected particles in 4 from high velocity flow 14 while at the same time maximizing the entrainment velocity of process particles 8. Turbulence in flow 11 is minimized through tapering end 13 of tube 4. Input 7 is a pressurized source that provides second laminar flow 14 through narrow gap 15, creating a laminar gas shroud at the open end of tube 3, which envelop plasma plume 16 and protects the inner wall of dielectric tube 2.

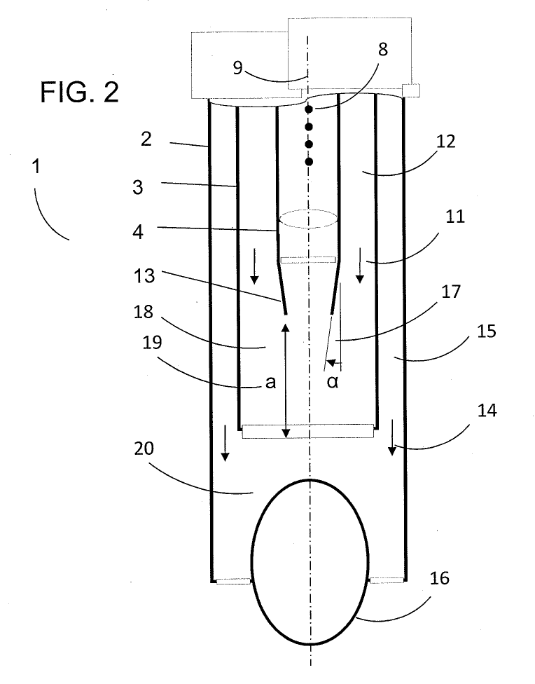

Referring to FIG. 2, dielectric torch 1 has characteristics to control gas flows in tubes 2 and 3 to ensure uniform thermal paths for particles 8 injected and guided through tube 4 along a central axis 9. Taper 13 is introduced at the end of tube 4 to minimize turbulence in gas flow 11 at the exit of gap 12 and to accelerate particles 8 in tube 4 through plasma 16. The tapering angle (α) 17 can take any value between 0 and about 45° to ensure a smooth transition of gas flow 11 from annular gap 12 to the inside cylindrical volume 18 in tube 3. This creates a laminar flow for gas flow 11 to entrain particles 8 along a rectilinear path nearest to axis 9. The length 19, indicated as “a”, of cylindrical volume 18 is preferably selected to be not less than one inch to ensure sufficient acceleration of particles 8 before entering hot zone 20.

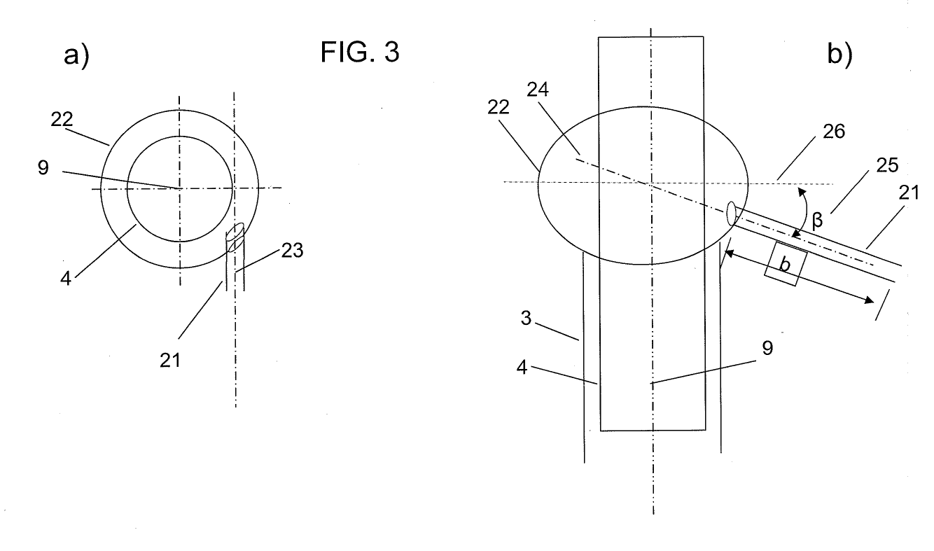

Referring to FIG. 3, there is illustrated a preferred embodiment for gas flow inputs to ensure stable laminar flows both for entrainment of particles 8 and for the symmetrical plasma flow in the hot zone of tube 2. Tube input 21 is sealed to gas chamber 22 along axis 23 as shown in FIG. 3a which shows a view from below of the gas bubble chamber 22. Axis 23 is off-center from central axis of injection 9 by a distance large enough so that flow of gas is substantially tangential to tube 4 or perpendicular to tube 4 but away from inner wall of gas bubble 22 so as to minimize generation of swirl flow inside gas chamber 22. The gas is subsequently carried all the way down the annular volume between tubes 3 and 4 towards the open end of the torch. In the side view FIG. 3b, tube 21 is shown sealed to gas chamber 22 along axis 24 making an angle β 25 with plane 26. At this angle, the gas flow is directed toward the top of gas chamber 22 so that the gas distributes evenly before heading down the annular volume between tubes 3 and 4.

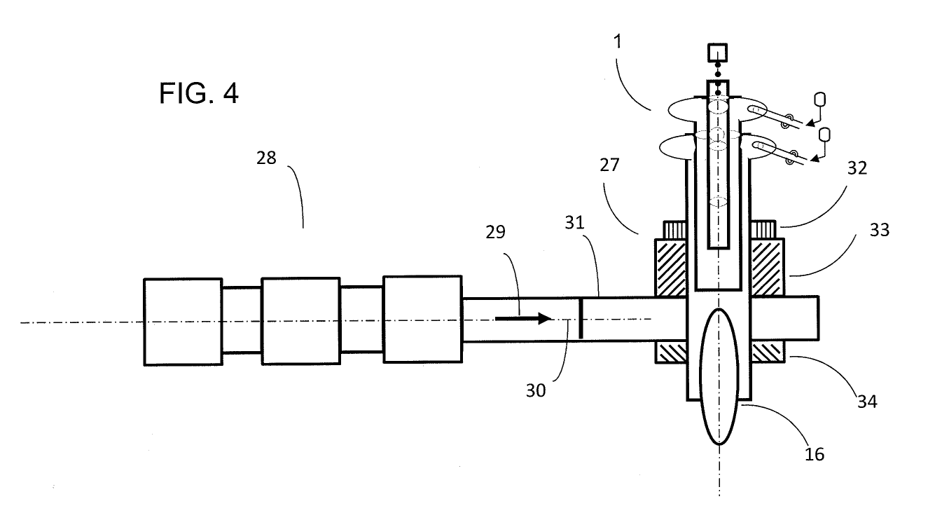

Referring to FIG. 4, the plasma torch 1 is integrated into a plasma chamber embodiment 27, which forms part of a microwave generated plasma apparatus 28 that produces plasma 16 for materials processing. Plasma apparatus 27 is designed, in part, as discussed in published U.S. Patent Application 2008/0173641-A1 issued Jul. 24, 2008, hereby incorporated by reference, so that the microwave radiation 29 propagates substantially parallel to the axis 30 through the plasma chamber 27 which penetrates waveguide 31.

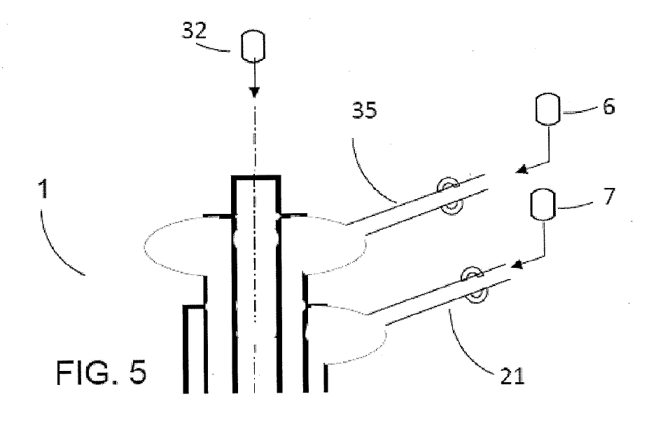

Referring to FIG. 5, plasma torch 1 can be used to process a combination of fluids using both particle source 32 and particle source 6. Gas source 7 is dedicated to gas flow which provides annular flow cooling to plasma torch 1. The gas flowing from gas source 7 can be air, individual components of air, an inert gas, a molecular gas, or any combination of gases. A multitude of fluids can be processed using plasma from particle source 6 and particle source 32. This mixing configuration of fluids includes processing any fluid flow from particle source 6 and processing any fluid flow from particle source 32.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

1. A microwave plasma torch comprising:
a set of staggered concentric tubes, an outer tube, an inner tube and a middle tube, said tubes comprising a dielectric material, said outer tube having an open end for passage of plasma, said middle tube disposed within and concentric to said outer tube and extending towards said open end but not beyond said outer tube, said inner tube disposed within said middle tube and extending towards said open end but not beyond said middle tube, said inner tube having a tapered end;
a first injection port for injecting gas between said outer and middle tubes towards said open end;
a second injection port for injecting gas between said middle and inner tubes towards said open end;

2. The plasma torch of claim 1 wherein there are at least three concentric tubes.

3. The plasma torch of claim 1 wherein a means is provided for inducing processing gas at said open end of said middle tube to form plasma using microwave energy generated from a source for microwave energy, said microwave energy propagated using a waveguide.

4. The plasma torch of claim 1 wherein laminar flow is created between said outer tube and said middle tube, said laminar flow shielding the plasma torch from plasma heat.

5. The plasma torch of claim 1 wherein laminar flow is created between said middle tube and said inner tube which permits a higher entrainment velocity for particles injected for deposition exiting said open end of inner tube and shields said particles from turbulent flow effects.

6. (canceled)

7. The plasma torch of claim 1 wherein the dielectric material is comprised of fused quartz.

8. The plasma torch of claim 1 wherein the three tubes are fused together using high heat.

9. The plasma torch of claim 1 wherein the tapered angle of the inner tube is between 0° and 45°.

10. The plasma torch of claim 1 wherein the middle tube is longer than the inner tube by at least 1 inch.

11. The plasma torch of claim 1 wherein the maximum outer diameter of the outer tube is no more than 3 cm when used with microwave radiation of frequency 2.45 GHz.

12. The plasma torch of claim 1 wherein the maximum outer diameter of the outer tube is no more than 9 cm when used with microwave radiation of frequency 915 MHz.

13. The plasma torch of claim 1 wherein the gas injection port to the outer tube is at an angle relative to a central axis of the torch and is substantially tangential to an inner surface of the outer tube.

14. The plasma torch of claim 1 wherein the gas injection port to the outer tube is at an angle relative to a central axis of the torch and is perpendicular to an inner surface of the outer tube.

15. The plasma torch of claim 1 wherein the gas injection port to the middle tube is at an angle relative to a central axis of the torch and is substantially tangential to an inner surface of the middle tube.

16. The plasma torch of claim 1 wherein the gas injection port to the middle tube is at an angle relative to a central axis of the torch and is perpendicular, to an inner surface of the middle tube.

17. The plasma torch of claim 1 wherein the material to be processed is injectable through the inner tube.

18. The plasma torch of claim 1 wherein the material to be processed is injectable through the annular gap between the inner and middle tubes.

19. A method for using the plasma torch of claim 1, said method comprising introducing material to be processed through said inner tube and also through annular gap between the inner and middle tubes.

20. The method of claim 19 wherein at least two materials are introduced.

21. The plasma torch of claim 1 wherein the material to be processed is selected from the group consisting of solid, liquid and gas.
